(19) United States
(12) Patent Application Publication
(10) Pub. No.: US 2025/0024355 A1
(43) Pub. Date: Jan. 16, 2025

(54) COMMUNICATION CONTROL SYSTEM AND COMMUNICATION CONTROL METHOD

(71) Applicant: HITACHI, LTD., Tokyo (JP)

(72) Inventors: Yuichi Igarashi, Tokyo (JP); Masanori Ishino, Tokyo (JP); Ryosuke Fujiwara, Tokyo (JP)

(73) Assignee: HITACHI, LTD., Tokyo (JP)

(21) Appl. No.: 18/714,381

(22) PCT Filed: Nov. 18, 2022
(86) PCT No.: PCT/JP2022/042904

§ 371 Date: May 29, 2024

(30) Foreign Application Priority Data
Dec. 9, 2021 (JP) 2021-199987

(51) Int. Cl. H04W 48/16; H04W 16/18; H04W 48/20

(52) U.S. Cl. CPC H04W 48/16; H04W 16/18; H04W 48/20

(57) ABSTRACT

A communication control system for controlling communication with a flying object that is taking off or landing, includes a control system including a computation device that executes a prescribed process, and a storage device that is connected to the computation device, and a flying object that communicates with the control system via a base station. The control system stores a radio map indicating a radio quality of each position and each flight altitude of the flying object and each base station. With reference to the radio maps of a plurality of altitudes, a base station that has a favorable radio quality is selected on a taking-off and landing route in a taking-off and landing port.

### INCORPORATION BY REFERENCE

The present application claims priority from Japanese patent application No. 2021-199987 filed on Dec. 9, 2021, the content of which is hereby incorporated by reference into this application.

### TECHNICAL FIELD

The present invention relates to a communication control system for controlling communication between a flying object and a management system, and more particularly, relates to a communication control method during taking-off and landing.

### BACKGROUND ART

In recent years, a system for delivering packages using a flying object, which is called “drone,” that takes off and lands vertically with respect to a landing surface, has been proposed. The delivering system using drones is configured to input data that indicates a horizontal flight plan route for a drone, to acquire a reference altitude value that indicates the altitude of a ground surface below a plurality of points on the flight plan route, and to use, as altitude data on the flight plan route, a value obtained by adding a flight altitude to the altitude reference value of a relevant point. Accordingly, the delivering system allows the drone to fly along the flight plan route without colliding with an obstacle.

In such a delivering system using drones, it is important to cause many drones to arrive at respective destinations and take off/land efficiently. As in the case of planes, drones require a control system. Communication between a flying object such as a drone and a control system is performed wirelessly, movement along a flight plan route is confirmed, and an adjustment such as a route change is made.

The background art of the technical field includes the following documents: Patent Document 1 (WO2016/190793); and Patent Document 2 (WO2018/159794). Patent Document 1 describes a wireless base station including a reception state acquisition unit that acquires either interference levels in multiple cells including an own cell being connected with a user device, or reception communication qualities of the user device in the multiple cells, and a power control unit that restricts transmission power if the interference levels or the reception communication qualities in the multiple cells acquired by the reception state acquisition unit are within a prescribed range.

Patent Document 2 describes a movement adjustment device for adjusting movement of wireless transmitters/receivers that are moving in accordance with a plan based on a route over a wireless communication network, and are simultaneously performing communication for an application having a service requirement in the wireless communication network, the wireless communication network including cells, the movement adjustment device being operable so as to acquire wireless network condition data concerning a cell group including the current cell in which a wireless transmitter/receiver is located and including multiple adjacent cells to which the wireless transmitter/receiver can move, to analyze the wireless network condition data in regards to satisfaction of the service requirement of the application, and to make an adjustment to the planned movement if the analysis indicates that the adjustment will improve satisfaction of the service requirement.

### SUMMARY OF THE INVENTION

### Problem to be Solved by the Invention

The aforementioned Patent Document 1 describes that a flying object moves in accordance with the plan based on a route via a wireless communication network, and flies while analyzing a wireless communication condition in a wireless communication area on a route from the current position to a next destination, and making an adjustment to the movement route so as to satisfy a radio quality required by an application installed in the flying object. However, according to this technology, an optimum cell is selected from among a plurality of cells, and thus, this is not suitable for movement such as taking off or landing along a height direction within one cell. In a case where the communication environment in one cell is deteriorated, or in a case where a plurality of base stations with which connection can be established are found, handover processing for connection switching to an optimum base station occurs. There has been a problem that communication cannot be performed during taking off and landing because a communication interruption occurs during handover processing.

In addition, Patent Document 2 indicates that a radio wave reception level and an interference level are managed by each altitude, and an optimum base station and optimum transmission power at a certain altitude are controlled. However, the total quality of wireless communication to be performed during height-direction movement from a landing start point, where downward movement is started, to a taking-off and landing port, which is a landing area, or to be performed during takeoff from the taking-off and landing port to an altitude at which a horizontal flight is started, is not taken into consideration. Therefore, there has been a problem that handover processing for switching to an optimum base station occurs, and a communication interruption occurs.

Moreover, no consideration is given to radio wave interference from an area above a flying object. Therefore, when a certain flying object is moving downwardly, a radio environment can be changed due to a plurality of flying objects that are on standby above the moving flying object. If the radio environment becomes worse than expected after downward movement for landing is started, the problem arises that handover processing for switching to an optimum base station occurs, and a communication interruption occurs.

In view of the above problems, an object of the present invention is to provide a system for allowing safety takeoff and landing without interrupting wireless communication when landing onto a taking-off and landing port from the air is made and when a takeoff from a taking-off and landing port into the air is made.

### Means for Solving the Problem

One representative aspect of the invention disclosed herein is as follows. That is, a communication control system for controlling communication with a flying object that is taking off or landing, including: a control system including a computation device that executes a prescribed process, and a storage device that is connected to the computation device; and a flying object that communicates with the control system via a base station, in which the control system stores a radio map indicating a radio quality of each position and each flight altitude of the flying object and each base station, and with reference to the radio maps of a plurality of altitudes, a base station that has a favorable radio quality is selected on a taking-off and landing route in a taking-off and landing port.

### Advantage of the Invention

According to one aspect of the present invention, when a flying object takes off from or lands onto a taking-off and landing port, the flight can be safely made without interruption of wireless communication. Any other problems to be solved, configurations, and effects will become apparent from the following explanation of embodiments.

### BRIEF DESCRIPTION OF THE DRAWINGS

FIG. 1 is a diagram depicting a schematic configuration of a system according to a first embodiment.

FIG. 2 is a block diagram depicting configurations of a flying object and a control system according to the first embodiment.

FIG. 3 is a diagram depicting one example of a radio map management screen according to the first embodiment.

FIG. 4 is a diagram depicting a configuration example of a radio map management table that is managed in FIG. 3.

FIG. 5 is a diagram depicting one example of a table configuration of a radio map according to the first embodiment.

FIG. 6 is a diagram depicting one example of a landing route onto a taking-off and landing port and radio maps according to the first embodiment.

FIG. 7 is a diagram depicting one example of a landing route onto a taking-off and landing port and radio maps according to the first embodiment.

FIG. 8 is a sequence diagram indicating a control flow in accordance with which the control system creates a radio map for a certain flying object, and communication is performed between the flying object and the control system.

FIG. 9 is a flowchart of a radio control determination process of determining the necessity of radio control with respect to a flying object.

FIG. 10 is a flowchart of a radio map creation process.

FIG. 11 is a block diagram depicting a configuration of a flying object according to a second embodiment.

FIG. 12 is a block diagram depicting a configuration of a flying object according to a third embodiment.

### MODES FOR CARRYING OUT THE INVENTION

According to embodiments of the present invention, in a taking-off and landing system including a flying object 101 and a control system 103, the control system 103 manages a flight plan, the position, the altitude, and the radio quality condition of the flying object 101, creates radio maps on the basis of information on a flight route from the current altitude of the flying object 101 to the taking-off and landing port 102 and respective radio qualities at altitudes, selects an optimum base station on the basis of the created radio maps, and indicates the optimum base station to the flying object 101. In addition, corresponding to the radio qualities determined from the radio maps, the control system 103 applies control on re-transmissions of radio data (radio packets) having the same content and control on consecutive transmissions of consecutively transmitting the same packet, to communication between the flying object 101 and the control system 103, so that the reliability of wireless communication is improved. Furthermore, the flying object 101 has a function of adjusting an antenna directivity for maintaining connection with an optimum base station during taking off and landing on the taking-off and landing port, a body control function for adjusting the antenna directivity, and a function for enabling steady connection with a specific base station.

### First Embodiment

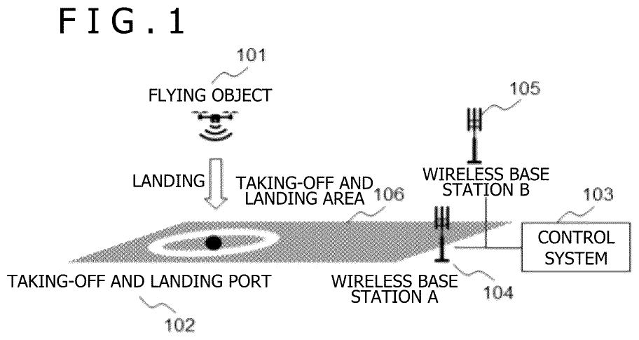

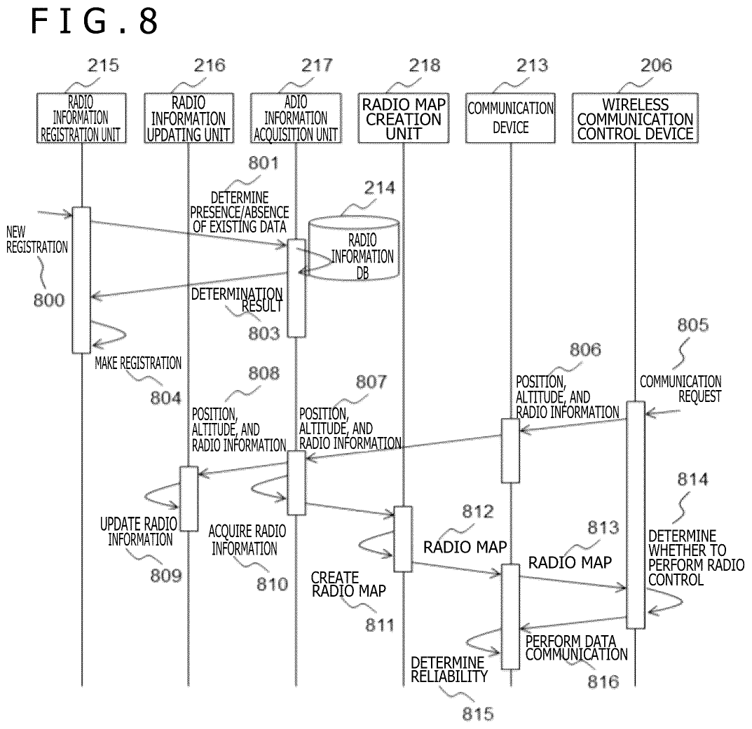

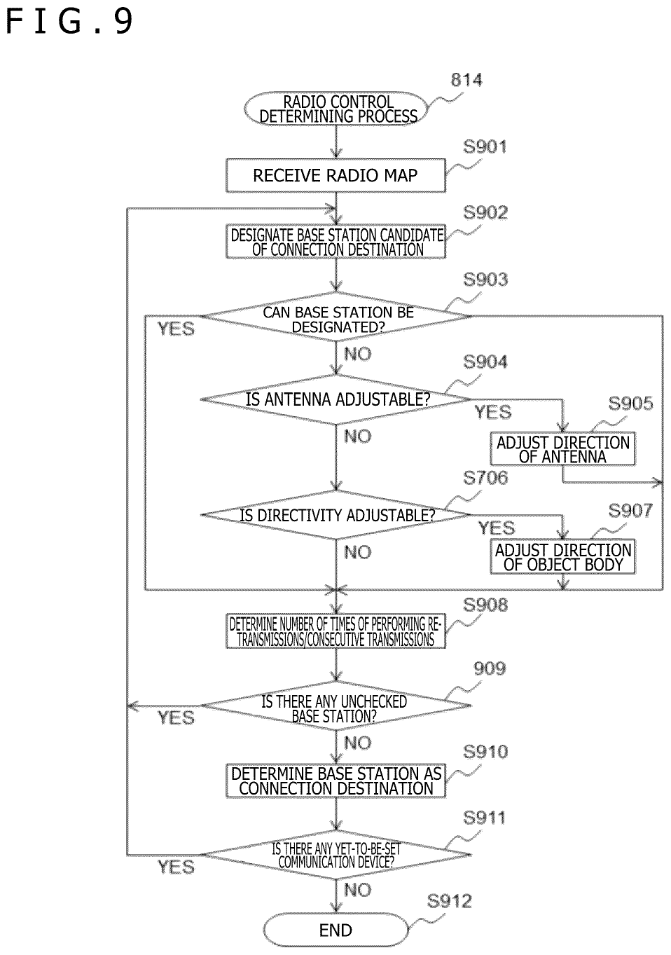

Hereinafter, the configuration of a first embodiment according to the present invention will be explained with reference to FIGS. 1 to 7, and processes in this embodiment will be explained with reference to FIGS. 8 and 9. It is to be noted that the present invention is not limited to the following embodiments, and modifications and applications thereof are included within the scope of the present invention under the technical concept of the present invention.

FIG. 1 is a diagram depicting a schematic configuration of a system according to the first embodiment of the present invention.

The system according to the first embodiment includes the flying object 101, the taking-off and landing port 102, the control system 103, and base stations 104 and 105.

The flying object 101 is a flying object such as a drone that can fly in a vertical direction. The flying object is, for example, a drone or an eVTOL that can take off and land vertically. It is to be noted that the present invention is applicable not only to an unmanned drone, but also to any other flying object such as a manned flying object that can take off and land vertically, without limited to the shape of the flying object and the flight form including a manned flight, an unmanned flight, an autonomously controlled flight, a flight controlled by a pilot, and the like.

The taking-off and landing port 102 is formed of a taking-off and landing area 106 where a flying object takes off and land, and the control system 103 that controls flight of the flying object 101 that is taking off or landing. The base stations A 104 and B 105 for communicating with the taking-off and landing area 106 and the flying object 101 that is taking off or landing, are disposed near the taking-off and landing port 102.

The taking-off and landing port 102 includes one taking-off and landing area 106 in FIG. 1, but may include a plurality of the taking-off and landing areas 106.

The control system 103 is connected with the taking-off and landing port 102 including the taking-off and landing area 106, the base station A 104, and the base station B 105, and manages the take-off/landing order and the take-off/landing timings of a plurality of the flying objects 101. In addition, since the control system 103 establishes stable communication with the flying object 101 and the control system 103, the control system 103 makes selection of a base station as a communication destination, and manages the quality of communication between the flying object 101 and the taking-off and landing area 106 during movement.

The base station A 104 is a wireless facility for performing communication between the flying object 101 and the control system 103, and is a base station of a communication carrier providing offering a wireless communication infrastructure for LTE or 5G, or is a communication base station of a private wireless network such as a wireless LAN, a private LTE, local 5G, or the like. It is to be noted that the radio system of the base station A 104 is not limited as long as the base station A 104 is a wireless facility or device that can realize wireless communication between the control system 103 side and the flying object 101. The explanation of the base station A 104 has been given above, but the base station B 105 has the same configuration.

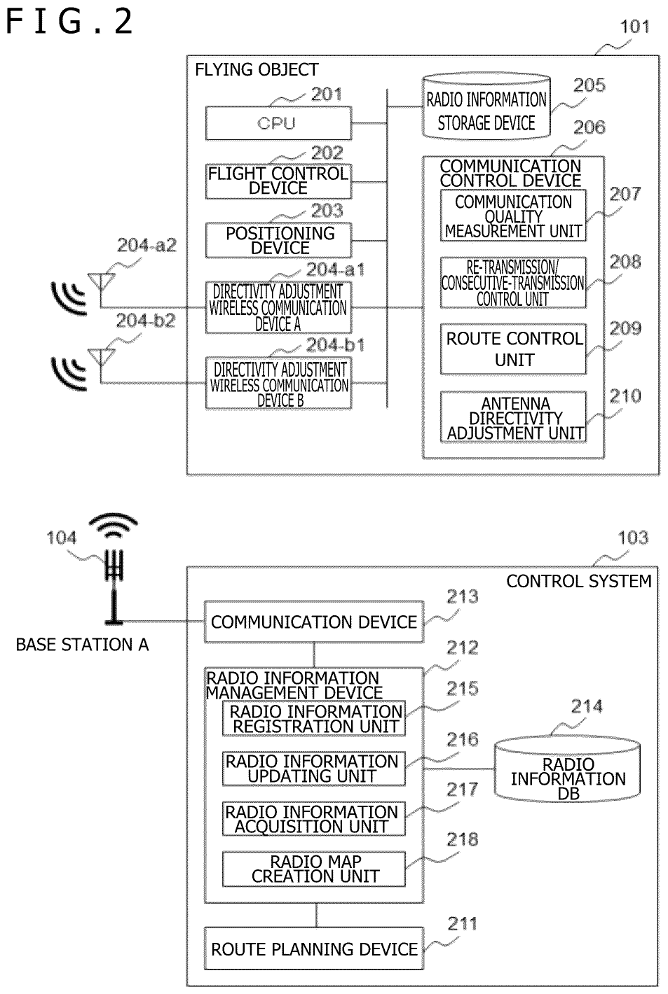

FIG. 2 is a block diagram depicting configurations of the flying object 101 and the control system 103 according to the first embodiment.

FIG. 2 depicts a representative configuration of the flying object 101. In a case where there are a plurality of the flying objects 101, which is not depicted in FIG. 2, each of the flying objects 101 has the same configuration.

The flying object 101 includes a CPU 201, a flight control device 202, a positioning device 203, a directivity adjustment wireless communication device A 204-a1, an antenna 204-a2, a directivity adjustment wireless communication device B 204-b1, an antenna 204-b2, a radio information storage device 205, and a communication control device 206.

The CPU 201 is a computation device that controls execution of all functions for controlling the flying object.

The flight control device 202 controls the body direction and the flight speed in accordance with a flight control program which is executed by the CPU 201.

The positioning device 203 measures current flying position information on the flying object 101, and for example, a positioning system such as a GNSS (Global Navigation Satellite System) can be used therefor. The positioning device 203 may have any other form or system as long as the positioning device 203 can acquire the position information on the flying object 101 with high precision. In a case where the positioning device 203 is a GNSS, the positioning device 203 can provide accurate time information.

The directivity adjustment wireless communication device A 204-a1 is a wireless device having a function of adjusting the directivity of the antenna 204-a2 which is connected with the directivity adjustment wireless communication device A 204-a1. The antenna 204-a2 has a non-directivity characteristic for transmitting/receiving radio waves of a constant intensity in a 360-degrees space, and a directivity characteristic for transmitting/receiving radio waves in a specific direction. For example, these characteristics can be realized by mechanically changing the direction of a directivity antenna, installing an adaptive array antenna having an electrically changeable directivity, or installing two antennas which are a non-directivity characteristic antenna and a directivity antenna. In addition, the directivity adjustment wireless communication device A 204-a1 is a wireless device having a transmission/reception function corresponding to a wireless communication system such as LTE or 5G utilized as a mobile network, or WiFi utilized as private radio waves.

Like the directivity adjustment wireless communication device A 204-a1, the directivity adjustment wireless communication device B 204-b1 has a transmitting/receiving function corresponding to a wireless system, and a function of adjusting the directivity of the antenna 204-b2. The wireless system of the directivity adjustment wireless communication device A 204-a1 may be identical to, or may be different from that of the directivity adjustment wireless communication device B 204-b1. In a case where the wireless systems are identical to each other, services for establishing connection with portable networks provided by different communication carriers, may be offered. Various combinations of the communication system of the directivity adjustment wireless communication device A 204-a1 and the communication system of the directivity adjustment wireless communication device B 204-b1, can be adopted.

The radio information storage device 205 stores radio information as well as the position information and the time information provided from the positioning device 203. The radio information to be stored in the radio information storage device 205 includes the intensities of radio waves received by the flying object 101 from the base stations 104 and 105, interference information, a communication speed, and a wireless communication KPI (Key Performance Indicator) such as a packet error rate.

The communication control device 206 is formed of a communication quality measurement unit 207, a re-transmission/consecutive transmission control unit 208, a route control unit 209, and an antenna directivity adjustment unit 210. The communication control device 206 is a device that controls communication.

The communication quality measurement unit 207 measures the intensity of a radio wave received by the flying object 101 from the base station 104 or 105, and the communication success probability of transmission to the base station 104 or 105.

The re-transmission/consecutive transmission control unit 208 has communication reliability improving functions including a re-transmission function of, in a case where the base station 104 or 105 fails to receive radio data (radio packets) transmitted from the flying object 101, transmitting the failed data again so as to improve the communication success probability, and a consecutive transmission function of transmitting the same data multiple times such that the base station can receive the data at least one time so as to improve the communication success probability. In addition, the re-transmission/consecutive transmission control unit 208 has a function of, in a case where the same data sets are received from the base station 104 or 105 as a result of a re-transmission function or consecutive transmission function of the base station 104 or 105, keeping one of the data sets and discarding the remaining data sets. To implement the re-transmission function and the consecutive transmission function, the data may have a structure to which a unique sequence number has been given, but any various configurations and implementation means can be adopted because, in the present embodiment, it is sufficient that the same data can be identified.

The route control unit 209 decides a communication route such that data transmitted from the flying object 101 is transmitted through either or both of a plurality of the wireless communication devices 204-a1 and 204-b1 included in the flying object 101. For example, by selection of one communication method having high reliability or by multiplexing, a route the communication reliability of which can be improved is decided. Like the re-transmission/consecutive transmission control unit 208, the route control unit 209 can adopt a variety of communication route decision methods.

The antenna directivity adjustment unit 210 transmits a control command for adjusting the direction of the antenna 204-a2 to the directivity adjustment wireless communication device A 204-a1, and a control command for adjusting the direction of the antenna 204-b2 to the directivity adjustment wireless communication device B 204-b1. In order to adjust the directions of the antennas, a method using a mechanical structure such as a motor, a method of selecting, from among a plurality of directivity antennas, one corresponding to a proper direction, or a method using an adaptive array antenna is used. Various directivity adjustment methods can be adopted.

The control system 103 includes a route planning device 211, a radio information management device 212, a communication device 213, a radio information DB 214, and the base station A 104.

The route planning device 211 plans a flight route of the flying object 101 to the taking-off and landing port 102.

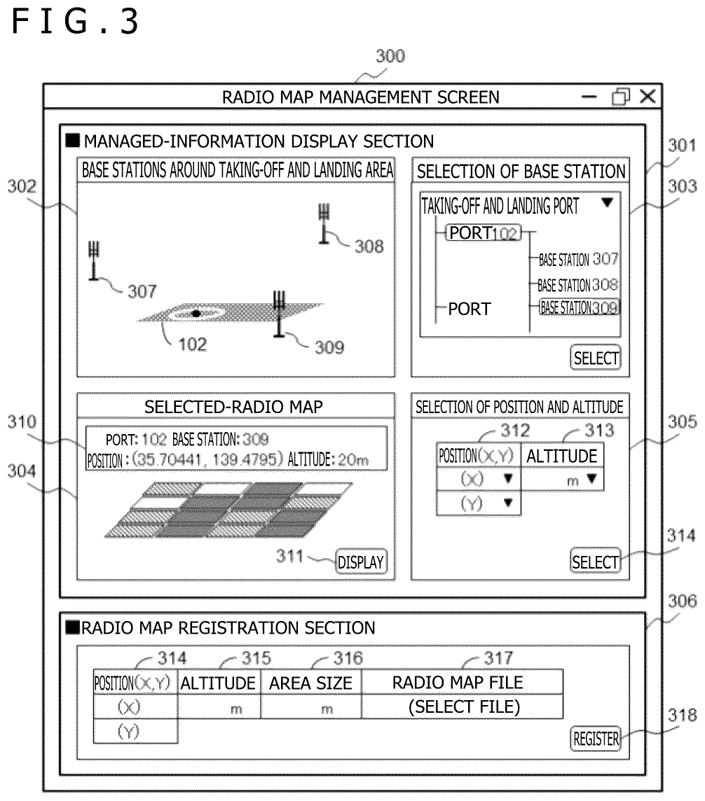

The radio information management device 212 includes a radio information registration unit 215, a radio information updating unit 216, a radio information acquisition unit 217, and a radio map creation unit 218. The radio information registration unit 215 provides a user interface (see FIG. 3) for registering the position and altitude of a flying object and radio information into the radio information DB 214. The radio information updating unit 216 updates registered radio information to the latest radio information, or adds the latest radio information to registered radio information. To record and manage one set of radio information for each position and altitude, it is preferable to update the radio information. To record and manage a plurality of data sets in time-series data for each position and altitude, it is preferable to additionally register radio information. The radio information acquisition unit 217 acquires information recorded in the radio information DB 214. The radio map creation unit 218 calculates one value to be registered in a radio map from radio information being managed by each base station corresponding to the position and altitude or the position, altitude, and time, and from the radio information acquired from the radio information DB 214 by the radio information acquisition unit 217 on the flight route created and managed by the route planning device 211, the position of a flying object, a base station to be connected, and the position and altitude. For example, a plurality of sets of radio information managed by altitudes in accordance with the flight route are added up, so that the value to be registered in the radio map can be calculated.

The communication device 213 can perform communication in accordance with the radio system of the flying object 101. The communication device 213 communicates with the flying object 101 via the base station A 104 through LTE or 5G which is a portable network, or WiFi which is a private radio system, for example. Here, the communication device 213 can adopt a variety of communication systems, in the same manner as in the flying object 101. In addition, the base station A 104 is ready to support the communication device 213. One base station is connected in FIG. 2, but a plurality of base stations may be connected.

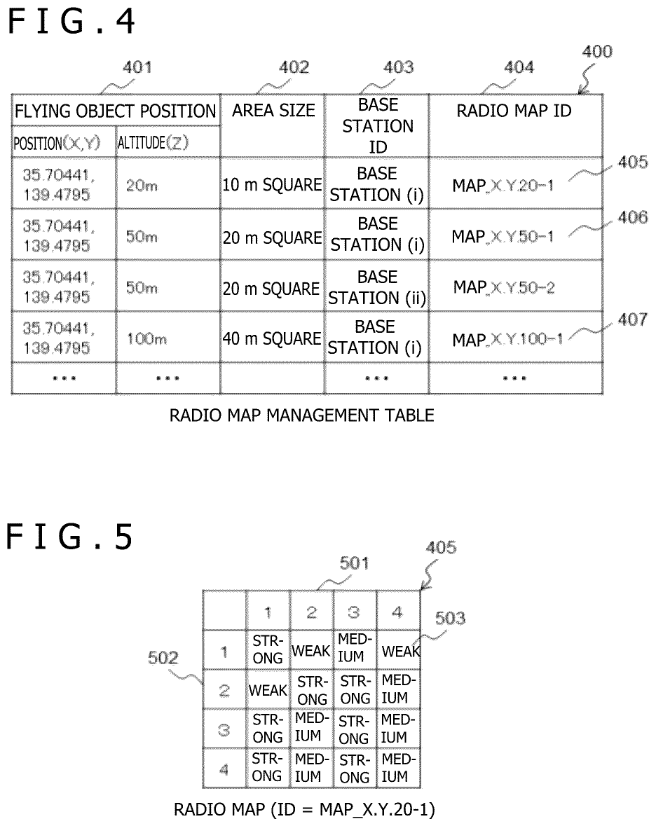

The radio information DB 214 stores radio information acquired by the flying object 101, and radio information acquired by the communication device 213 of the control system 103. Since the radio information is managed in each area size, as shown in a radio map management table 400 (see FIG. 4), an area is calculated from the position and altitude in the radio information measured by the flying object 101, and the radio information is stored in a table of the corresponding area. In the present embodiment, a variety of types of databases can be adopted.

FIG. 3 is a diagram depicting one example of a radio map management screen 300 according to the first embodiment.

The radio map management screen 300 includes a managed-information display section 301 and a radio map registration section 306.

The managed-information display section 301 is a user interface including an indication region 302 of base stations around the taking-off and landing area, a base station selection region 303, an indication region 304 of a selected radio map, and a position and altitude selection region 305.

In the indication region 302 of a base station around the taking-off and landing area, a base station that is present around the taking-off and landing port selected in the base station selection region 303 is indicated. For example, in the depicted indication region 302 of a base station around the taking-off and landing area, the taking-off and landing port 102 and base stations 307 to 309 are plotted on a map.

The indication region 304 of a selected radio map indicates a radio map of the base station selected in the base station selection region 303, at the position and altitude selected in the position and altitude selection region 305. A base station is selected in the base station selection region 303, a selection button 314 in the position and altitude selection region 305 is operated, and then, a display button 311 is operated to display the radio map. However, the display button 311 is not necessarily required. A corresponding radio map may be automatically displayed after a base station, a position, and an altitude are selected. A variety of implementation forms can be adopted.

The radio map registration section 306 is a user interface that is used to register a new radio map, register an additional radio map, or update a radio map. A position 314, an altitude 315, an area size 316 of a radio map to be registered, and a radio map file 317 for expressing radio information are designated for the flying object 101, and a registration button 318 is operated to register a radio map. As the format of the radio map file, any format can be adopted as long as the format is a predetermined one such as a CSV (Comma Separated Values) format or a JSON (JavaScript Object Notation) format.

FIG. 4 is a diagram depicting a configuration example of the radio map management table 400 that is managed in FIG. 3.

In the radio map management table 400, a flying object position 401, an area size 402, a base station ID 403, and a radio map ID 404, are managed by columns. The position (X, Y) of the flying object position 401 is expressed by latitude and longitude information, and the altitude (Z) is expressed by the altitude with respect to the ground surface, for example. In addition, the area size 402 designates the mesh size of the radio map. The radio maps are managed by altitudes (Z) of the flying object position 401 such that each of the radio maps is centered on the position (X, Y). Therefore, radio information acquired at a certain position (X, Y) is a value representing a distance to a position away from the position (X, Y) by a value obtained by dividing the area size 402 by 2.

The area size 402 which is recorded in the radio map management table 400 may be changed depending on the altitude, or may be set to be constant irrespective of the altitude. If the area size is managed so as to be changed depending on the altitude, the difference in communication distance characteristics among the altitudes can be addressed. For example, communication at a high altitude can be regarded as line-of-sight communication because there are no or less obstacles at such a high altitude than at a low altitude. That is, radio wave attenuation due to the communication distance at a high altitude is less than at the ground. Therefore, radio information may be managed by a large area. An effect of reducing the storage area in a database, and being capable of making a determination corresponding to communication distance characteristics, can be obtained. On the other hand, when management based on equal area sizes is performed regardless of altitudes, as depicted in FIG. 7, the management of radio maps becomes easy.

The radio map ID 404 is identification information or a name for uniquely identifying a registered radio map.

FIG. 5 is a diagram depicting one example of a table configuration of a radio map. FIG. 5 indicates an example of a radio map 405.

In the radio map 405, cells 501 arranged in a vertical direction (having the same X-axis value) constitute each column, and cells 502 arranged in a horizontal direction (having the same Y-axis value) constitute each row. The radio map 405 is formed of values 503 of cells that are sectioned by the columns and the rows. In the present embodiment, the values 503 are expressed by strong, medium, and weak levels. Alternatively, numerical values directly representing measurement results as radio information, or numerical values representing radio qualities such as radio intensities, packet error rates, or delays, are sufficient. A variety of values can be adopted therefor.

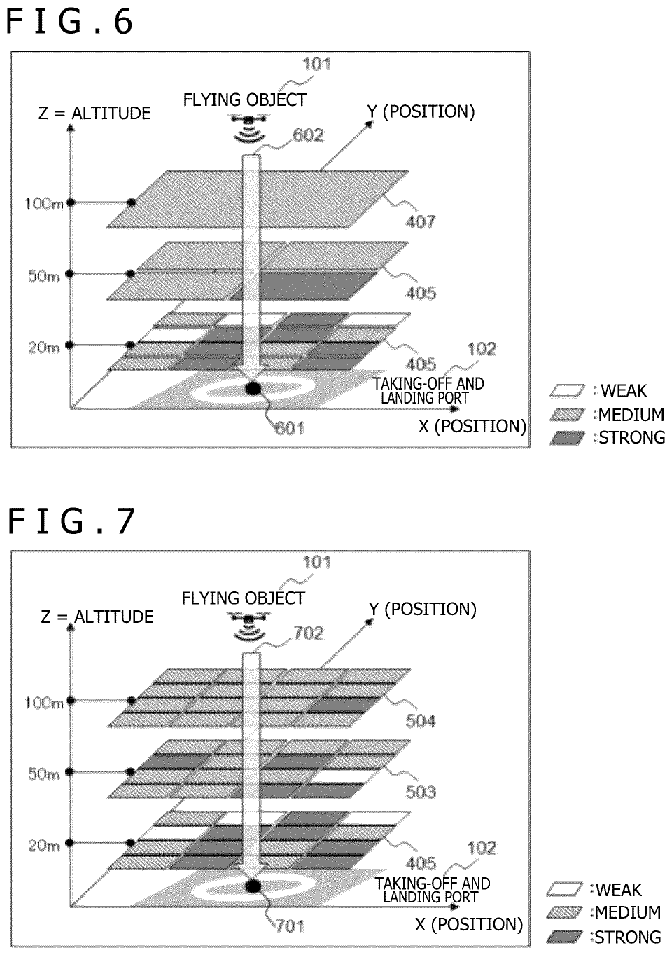

FIG. 6 is a diagram depicting one example of a route for landing from a certain altitude to the taking-off and landing port, and radio maps, and depicts selection of values on radio maps corresponding to a flight route for landing from a position 602 of the flying object 101 onto a taking-off and landing point 601 in the taking-off and landing port 102.

In FIG. 6, a radio map 405 of an altitude of 20 m, a radio map 406 of an altitude of 50 m, and a radio map 407 of an altitude of 100 m, are managed as radio maps around the taking-off and landing port 102. The area sizes in the respective radio maps are 10, 20, and 40 m, as shown in the radio map management table 400 in FIG. 4. Here, corresponding to a passing route, radio information which represents a radio quality at a landing time is calculated from three values: the value of one cell of a mesh which is sectioned into 16 parts in the radio map 405; the value of one cell of a mesh which is sectioned into 4 parts in the radio map 406; and the value of a cell of a mesh which is not sectioned in the radio map 407. In this manner, the management can be performed while changing an area size corresponding to an altitude.

FIG. 7 is a diagram depicting one example of a route for landing from a certain altitude onto the taking-off and landing port, and radio maps, and depicts selection of values of radio maps corresponding to a flight route for landing from a position 702 of the flying object 101 onto a taking-off and landing point 701 in the taking-off and landing port 102.

In the example depicted in FIG. 7, the radio map 405 of an altitude of 20 m, a radio map 703 of an altitude of 50 m, and a radio map 704 of an altitude of 100 m, are managed as radio maps around the taking-off and landing port 102. The area sizes in all the radio maps are 10 m. In the same manner as in FIG. 6, corresponding to a passing route, radio information which represents a radio quality at a landing time is calculated from three values: the value of one cell of a mesh which is sectioned into 16 parts in the radio map 405; the value of one cell of a mesh which is sectioned into 16 parts in the radio map 703; and the value of one cell of a mesh which is sectioned into 16 parts in the radio map 704. In this manner, the management can be performed with the area size set to be equal to each other regardless of an altitude.

Next, with reference to FIGS. 8 to 10 and on the basis of radio maps, an explanation will be given of the flow of controlling wireless communication during taking off and landing of the flying object 101, and of an operation flow of determining control information.

FIG. 8 is a sequence diagram depicting a control flow in accordance with which the control system 103 creates a radio map for a certain flying object, and communication is performed between the flying object 101 and the control system 103.

The radio information registration unit 215 receives a new radio map registration request from the radio map registration section 306 of the radio map management screen 300 (800), and makes an inquiry about the presence/absence of an existing radio map to the radio information acquisition unit 217 (801). Upon receiving the existing data confirmation request, the radio information acquisition unit 217 tries to acquire a requested radio map from the radio information DB 214. When the requested radio map is successfully acquired, an existing radio map is present. When acquisition of the requested radio map fails, no existing map is present. The radio information acquisition unit 217 sends a determination result 803 in response to the existing data confirmation request, through the radio information acquisition unit 217 to the radio information registration unit 215. In accordance with the returned determination result 803, the radio information registration unit 215 executes a radio map registration, updating, and adding process (804).

Next, when the communication quality measurement unit 207 of the flying object 101 receives a communication start request 805, a process for checking the quality of communication between the base station 104 connected to the control system 103 and the flying object 101, is executed. First, the communication quality measurement unit 207 of the flying object 101 transmits the position, the altitude of the flying object 101, and acquired radio information to the communication device 213 of the control system 103 (806). The communication device 213 transmits the received position, altitude, and radio information to the radio information acquisition unit 217 (807), and acquires a relevant radio wave map on the basis of the position and the altitude (810). In addition, new radio information received from the flying object 101 is transmitted to the radio information updating unit 216 (808), and radio information updating is performed (809).

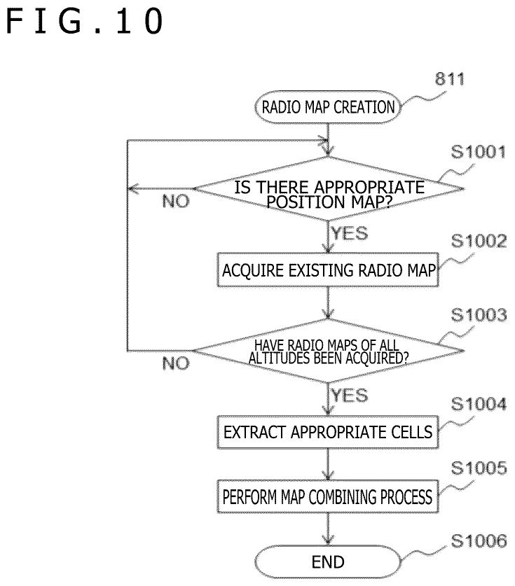

The radio map creation unit 218 creates a radio map between the flying object 101 and the taking-off and landing port on the basis of the radio information acquired from the radio information acquisition unit 217 (811). The details of this radio map creation process 811 will be explained later with reference to FIG. 10. The radio map creation unit 218 transmits the created radio map to the communication device 213 (812). The communication device 213 transmits the received radio map to the flying object 101 through wireless communication (813). Here, the communication device 213 determines a radio wave reliability on the basis of the created radio map (815). In the reliability determination process 815, in order to improve the communication reliability, operation parameters for the re-transmission/consecutive transmission control unit and the route control unit of the communication device 213 are determined, and communication with the flying object 101 is performed by a determined communication method. The re-transmission/consecutive transmission control unit of the communication device 213 in the control system also makes determinations in the same manner as in the re-transmission/consecutive transmission control unit 208 and the route control unit 209, so that the communication reliability is improved.

Upon receiving the radio map, the communication quality measurement unit 207 determines the necessity of radio control (814) in the same manner as in the communication device 213 of the control system 103, so that the number of times of performing consecutive transmissions/re-transmissions and a transmission route are determined. The details of the radio control determination process 814 will be explained later with reference to FIG. 9.

FIG. 9 is a flowchart of the radio control determination process 814 of determining necessity of radio control with respect to the flying object. It is to be noted that the flowchart in FIG. 9 indicates control that is performed in a case where all the functions of the first embodiment and second and third embodiments, which will be explained later, are installed. Steps corresponding to functions that are not installed in an embodiment, are skipped. That is, the first embodiment corresponds to steps S704 to S705, the second embodiment corresponds to steps S706 to S707, and the third embodiment corresponds to step S703.

In the radio control determination process 814, in step S901 first, the communication quality measurement unit 207 receives radio maps from the radio map creation unit 218. In step S902, a base station candidate of a connection destination is designated from a plurality of the received radio maps. Since radio maps are managed for each base station, there is a possibility that one or more connection candidates are present. In step S902, for each of the connection candidates, a base station candidate for ensuring a communication reliability that is suitable as a connection destination for which steps S903 to S910 will be executed, is designated. Then, the process proceeds to step S903.

In step S903, whether or not an applicable base station can be designated is determined. In a case where a specific base station can be designated, the process proceeds to step S908 because continuous connection can be established with the designated base station without controlling the object body or adjusting the antenna directivity. In contrast, in a case where a specific base station cannot be designated, the process proceeds to step S904.

In step S904, whether or not the directivity of an antenna of the flying object 101 is adjustable, is determined. In a case where a structure capable of adjusting the antenna directivity is provided to obtain a desired directivity, the process proceeds to step S905. In a case where the antenna directivity is not adjustable, the process proceeds to step S906.

In step S905, the antenna directivity is adjusted toward a direction for improving a directivity toward the base station so as to continue communication with the base station. After an adjustment parameter is determined, the process proceeds to step S908.

In step S906, whether or not the antenna directivity can be adjusted by body control of the flying object, is determined. In a case where the directivity can be adjusted with respect to the base station when the flying object body is rotated in a horizontal direction, the process proceeds to step 907 (S907). In a case where the directivity is not adjustable, the process proceeds to step S908.

In step S908, the number of times of performing re-transmissions and the number of times of performing consecutive transmissions for improving the reliability of communication with the base station, are determined. In a case where the same radio packet is re-transmitted by the number of times determined in this step, and where the same application data is consecutively transmitted by the number of times determined in this step (for example, the number of times of performing re-transmissions and the number of times of performing consecutive transmissions are set to 2 and 3, respectively), up to 9 opportunities (the number of times of performing consecutive transmissions×the number of performing re-transmissions+1) of performing wireless transmissions can be obtained for the same application data, compared to a case where the number of times of performing re-transmissions is set to zero and the number of times of performing consecutive transmissions is set to zero. Therefore, to attain successful wireless communication, it is sufficient that at least one of the up to 9 radio packets reaches the destination base station. Accordingly, the reliability is improved. In the aforementioned manner, parameters for improving the reliability of wireless communication are determined in this step. Besides the number of times of performing re-transmissions or the number of times of performing consecutive transmissions, a function for improving the communication reliability can be added to the present step in the present embodiment. A variety of reliability improving functions can be adopted.

In step S909, whether or not there is an unchecked base station is confirmed. In a case where there is an unchecked base station, the process returns to step S902 to execute the process for the next base station candidate. In contrast, in a case where the process for all the base station candidates has been executed, the process proceeds to step S910.

In step S910, an optimum base station is selected from among the base station candidates in view of the radio maps and the communication reliability. For example, in a case where the intensity of radio waves from a base station is taken as a reference, a base station having the highest radio wave intensity on a route from the current position of the flying object, which is calculated from a plurality of radio maps being managed by altitudes, to a landing point, is selected. After a base station is selected, the process proceeds to step S911.

In step S911, whether there is a yet-to-be-set communication device is determined. The flying object 101 has one or more wireless communication devices. Thus, in a case where any one of the communication devices has not been set, the process proceeds to step S902. In a case where all the communication devices have been set, the process proceeds to step S912 to execute the process for the next communication device. On the other hand, in a case where the processes for all the communication devices have been executed, the process ends.

FIG. 10 is a flowchart of the radio map creation process 811.

In the radio map creation process 811, in step S1101 first, whether or not there is an existing radio map corresponding to the position and altitude, is determined. In a case where there is an existing radio map, the process proceeds to step S1002. In a case where there is no existing radio map, a radio map corresponding to the next position and altitude is searched for.

In step S1102, an applicable radio map is acquired from the radio information DB 204, and then, the process proceeds to step S1003.

In step S1003, whether or not radio maps of all altitudes within a section from the landing start point of the flying object 101 to the taking-off and landing port 102 or a section from the taking-off and landing port 102 to a flight altitude after taking off, have been acquired, is determined. In a case where the radio maps of all altitudes have been acquired, the process proceeds to step S1004. In a case where any one of the radio maps has not been acquired, the process returns to step S1001.

In step S1004, in order to acquire radio information on a position on the flight route of the flying object 101, a relevant cell in each of the radio maps is extracted on the basis of the position information and the cell size, and a radio information value of the extracted cell is stored. After the cell values are extracted and stored from all the radio maps, the process proceeds to step S1005.

In step S1005, a map combining process using all the values of the relevant cells in the radio maps stored in step 1004 is performed. For example, in the map combining process, all the cell values may be added up. In the map combining process, a variety of modifications of, for example, performing the addition while changing the weight corresponding to each altitude, may be made. After the map combining process is completed, the process ends in step S1006.

As explained so far, according to the first embodiment, disconnection of wireless communication due to handover processing during taking off and landing of the flying object 101 can be suppressed, and further, the reliability of wireless communication can be improved to be suited for the route.

### Second Embodiment

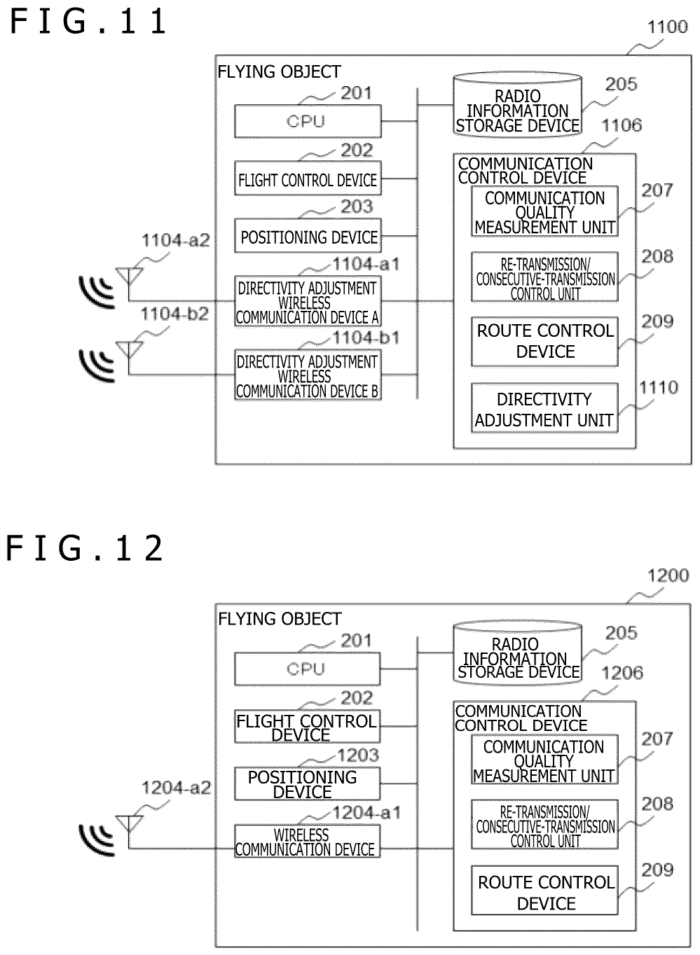

In the first embodiment, in order to suppress handover during taking off and landing, a mechanical structure capable of adjusting an antenna directivity for maintaining connection with a certain base station is required in the antenna 204-a2 or the antenna 204-b2, so that the body weight of the flying object is increased. The second embodiment offers an example of addressing this problem by changing the body direction of a flying object itself without requiring a mechanical structure having an adjustment function. The configuration of the flying object of the second embodiment depicted in FIG. 11 is different from that of the first embodiment. This configuration corresponds to steps S706 to S707 of the flowchart in FIG. 9. It is to be noted that a configuration different from that in the first embodiment will be mainly explained in the second embodiment, and a configuration or a process identical to that in the first embodiment is denoted by the same reference numeral, and an explanation thereof will be omitted.

FIG. 11 is a block diagram depicting a configuration of a flying object 1101 according to the second embodiment.

The flying object 1101 includes the CPU 201, the flight control device 202, the positioning device 203, a wireless communication device A 1104-a1, the antenna 204-a2, a wireless communication device B 1104-b1, the antenna 204-b2, the radio information storage device 205, and a communication control device 1106.

The CPU 201, the flight control device 202, the positioning device 203, the antenna 204-a2, the antenna 204-b2, and the radio information storage device 205 are identical to those of the first embodiment.

The wireless communication device A 1104-a1 and the wireless communication device B 1104-b1 are wireless devices each having a transmission/reception function corresponding to a wireless communication system such as LTE or 5G utilized as a mobile network, or WiFi utilized as private radio waves. The wireless system of the wireless communication device A 1104-a1 may be identical to or may be different from that of the wireless communication device B 1104-b1.

The communication control device 1106 is formed of the communication quality measurement unit 207, the re-transmission/consecutive transmission control unit 208, the route control unit 209, and a directivity adjustment unit 1110, as in the first embodiment. The communication control device 1106 controls communication.

The directivity adjustment unit 1110 indicates, to the flight control device 202 of the flying object 101, a body direction with respect to a base station to be connected in which the quality of communication with the base station can be favorably maintained. That is, in the second embodiment, the direction of the antenna that is fixedly mounted on the object body is controlled by controlling the direction of the flying object 101.

As explained so far, according to the second embodiment, disconnection of wireless communication due to handover processing during taking off and landing of the flying object 101 can be suppressed without installation of an antenna directivity adjustment mechanism which may become a cause of a weight increase of the flying object 101, and further, the reliability of wireless communication can be improved to be suited for the route.

### Third Embodiment

In the second embodiment, in order to suppress handover during taking off and landing, it is necessary to control the body direction of the flying object 101 so as to maintain connection with a certain base station. Therefore, motion of the object body is restricted. The third embodiment offers an example of addressing this problem without using a mechanical control function. The configuration of a flying object of the third embodiment depicted in FIG. 12 is different from those of the first and second embodiments. This configuration corresponds to step S703 of the flowchart in FIG. 9. It is to be noted that, a configuration different from that in the first or second embodiment will be mainly explained in the third embodiment, and a configuration or a process identical to that in the first or second embodiment is denoted by the same reference numeral, and an explanation thereof will be omitted.

FIG. 12 is a block diagram depicting a configuration of a flying object 1201 according to the third embodiment.

The flying object 1201 includes the CPU 201, the flight control device 202, the positioning device 203, a wireless communication device 1204-a1, an antenna 1204-a2, the radio information storage device 205, and a communication control device 1206.

The CPU 201, the flight control device 202, the positioning device 203, and the radio information storage device 205 are identical to those in the first embodiment and the second embodiment.

The wireless communication device 1204-a1 is a wireless device having a transmission/reception function corresponding to a wireless communication system such as LTE or 5G utilized as a mobile network, or WiFi utilized as private radio waves. The wireless communication device 1204-a1 has a function of establishing connection with a designated base station. For example, an SSID for identifying an access point of a wireless LAN, or a base station ID of a mobile network can be used to designate a connection destination. If such an SSID or a base station ID can be designated, unintended switching to another base station can be suppressed. Neither the antenna directivity adjustment mechanism of the first embodiment nor the body control process of the second embodiment is required.

The communication control device 1206 is formed of the communication quality measurement unit 207, the re-transmission/consecutive transmission control unit 208, and the route control unit 209, which are the same as in the first embodiment. The antenna directivity adjustment unit 210 of the first embodiment and the directivity adjustment unit 1110 of the second embodiment are not required.

As explained so far, according to the third embodiment, disconnection of wireless communication due to handover processing during taking off and landing of the flying object 101 can be suppressed without any restriction on flight of the flying object 101, and further, the reliability of wireless communication can be improved to be suited for the route.

According to the aforementioned embodiments, radio information in which a flight altitude and a flight route are taken into consideration can be obtained, and disconnection of communication with a wireless station due to unnecessary handover can be suppressed by radio information management and communication control during taking off and landing of the flying object 101.

It is to be noted that the present invention is not limited to the aforementioned embodiments, and encompasses various modifications and equivalent configurations within the concept of the attached claims. For example, the aforementioned embodiments have provided a detailed explanation of the present invention for easy understanding. The present invention is not necessarily limited to an embodiment including all the explained configurations. In addition, a part of the configurations of any one of the embodiments may be replaced with a configuration of another one of the embodiments. Moreover, a configuration of any one of the embodiments may be added to a configuration of another one of the embodiments. Furthermore, addition, deletion, or replacement of another configuration may be made for a part of the configurations of each of the embodiments.

In addition, the aforementioned configurations, functions, processing units, and processing means may be implemented by hardware by designing a part or all of them on an integrated circuit, for example, or may be implemented by software by a processor interpreting and executing a program for executing the functions.

Information on the program for executing the functions, a table, a file, etc., can be stored in a storage device such as a memory, a hard disk, or an SSD (Solid State Drive), or in a recording medium such as an IC card, an SD card, or a DVD.

In addition, a control line or an information line that has been described is considered to be necessary in the explanation, and thus, not all control lines or information lines that need to be mounted have been described. It can be considered that almost all the structures are mutually connected in actuality.

1. A communication control system for controlling communication with a flying object that is taking off or landing, the communication control system comprising:
a control system including a computation device that executes a prescribed process, and a storage device that is connected to the computation device; and
a flying object that communicates with the control system via a base station, wherein
the control system stores a radio map indicating a radio quality of each position and each flight altitude of the flying object and each base station, and
with reference to the radio maps of a plurality of altitudes, a base station that has a favorable radio quality is selected on a taking-off and landing route in a taking-off and landing port.

2. The communication control system according to claim 1, wherein
the flying object
has a function of adjusting a directivity of an antenna to communicate with the base station, and
controls the directivity toward a direction of a base station to become a communication partner, in accordance with the radio maps of the plurality of altitudes so as to maintain connection with the selected base station.

3. The communication control system according to claim 1, wherein
the flying object
has a function of adjusting a directivity of an antenna to communicate with the base station by controlling a body direction of the flying object, and
controls the directivity toward a direction of a base station to become a communication partner, in accordance with the radio maps of the plurality of altitudes so as to maintain connection with the selected base station.

4. The communication control system according to claim 1, wherein
an area size based on which radio qualities are managed on the radio map, varies according to altitudes.

5. The communication control system according to claim 1, wherein
the control system determines number of times of performing re-transmissions and/or number of times of performing consecutive transmissions of data between the flying object and the control system, corresponding to a radio quality which is determined based on the radio maps of the plurality of altitudes, so that quality and reliability of communication between the flying object and the control system are ensured.

6. The communication control system according to claim 1, wherein
the control system
determines whether a specific base station can be designated, and performs control to establish continuous connection with the specific base station if the specific base station can be designated,
determines whether a directivity of an antenna of the flying object is adjustable, and performs control to set the directivity of the antenna toward the specific base station if the directivity of the antenna is adjustable, and
determines whether the directivity of the antenna is adjustable by body control of the flying object, and performs control to set the directivity of the antenna toward the specific base station if the directivity of the antenna is adjustable.

7. A communication control method for controlling communication with a flying object that is taking off and landing through a control system,
the control system including a computation device that executes a prescribed process, and a storage device that is connected to the computation device, the control system being configured to communicate with the flying object via a base station,
the control system storing a radio map indicating a radio quality of each position and each flight altitude of the flying object and each base station,
the communication control method comprising:
selecting, by the control system, a base station that has a favorable radio quality on a taking-off and landing route in a taking-off and landing port, with reference to the acquired radio maps of a plurality of altitudes; and
maintaining, by the flying object, connection with the selected base station during taking off and landing in the taking-off and landing port.

8. The communication control method according to claim 7, wherein
the flying object has a function of adjusting a directivity of an antenna to communicate with the base station, and
the communication control method further includes
controlling, by the flying object, the directivity toward a direction of a base station to become a communication partner, in accordance with the combined radio map, so that connection with the selected base station is maintained.

9. The communication control method according to claim 7, wherein
the flying object has a function of adjusting a directivity of an antenna to communicate with the base station by controlling a body direction of the flying object, and
the communication control method further includes
controlling, by the flying object, the directivity toward a direction of a base station to become a communication partner, in accordance with the combined radio map, so that connection with the selected base station is maintained.

10. The communication control method according to claim 7, wherein
an area size based on which radio qualities are managed on the radio map, varies according to altitudes.

11. The communication control method according to claim 7, wherein
the control system determines number of times of performing re-transmissions and/or number of times of performing consecutive transmissions of data between the flying object and the control system, corresponding to a radio quality which is determined based on the radio maps of the plurality of altitudes, so that quality and reliability of communication between the flying object and the control system are ensured.

12. The communication control method according to claim 7, wherein
the control system
determines whether a specific base station can be designated, and performs control to establish continuous connection with the specific base station if the specific base station can be designated,
determines whether a directivity of an antenna of the flying object is adjustable, and performs control to set the directivity of the antenna toward the specific base station if the directivity of the antenna is adjustable, and
determines whether the directivity of the antenna is adjustable by body control of the flying object, and performs control to set the directivity of the antenna toward the specific base station if the directivity of the antenna is adjustable.
